(19) United States
(12) Patent Application Publication
(10) Pub. No.: US 2013/0152906 A1
(43) Pub. Date: Jun. 20, 2013

(54) INTERCOOLER ASSEMBLY

(71) Applicant: Michael Mater, Dunnville (CA)

(72) Inventor: Michael Mater, Dunnville (CA)

(21) Appl. No.: 13/676,677

(22) Filed: Nov. 14, 2012

Related U.S. Application Data
(60) Provisional application No. 61/576,114, filed on Dec. 15, 2011.

(51) Int. Cl. F02M 31/20

(52) U.S. Cl. CPC F02M 31/20
USPC 123/542

(57) ABSTRACT

An intercooler assembly for cooling charge air to be delivered to an internal combustion engine is disclosed. The said assembly is disposed along an axis in the axial direction, including an intercooler housing having a housing cavity for receiving an intercooler core therein. Conventional cooling fluid is channeled axially through an axial chamber of the intercooler core for cooling the core and charge air is channeled around the outer surface of the core for cooling the charge air, wherein the core assembly further including a means for rotating the intercooler core about the axis, thereby increasing the cooling of the charge air as it flows around the outer surface of the intercooler core.

The present application claims the benefit of previously filed U.S. Provisional Application 61/576,114 filed Dec. 15, 2011 under the title INTERCOOLER ASSEMBLY in the name of Michael Mater.

### FIELD OF THE INVENTION

The present device relates to intercoolers and more particularly relates to an intercooler assembly including a rotating intercooler core.

### BACKGROUND OF THE INVENTION

A number of prior art devices have been described and patented and in particular in U.S. Pat. No. 6,311,676 titled INTERCOOLER ARRANGEMENT FOR A MOTOR VEHICLE ENGINE by Oberg et al., issued Nov. 6, 2001 which describes the current most popular intercooler core assembly arrangement.

Some prior art devices have described a rotating cooler core which in alternating fashion passes through a cooling fluid and the charging medium through the internal portion of the core and in some cases use the same channels for the cooling medium as well as the charging medium.

For example European Patent EP 1775440 registered Sep. 13, 2006 under the title intercooler for cooling the intake air of an internal combustion engine of a vehicle by Mueller et al., describes one such system.

British patent GB2077895 titled Improvements Relating to Turbo Charging of Internal Combustion Engines filed Jun. 17, 1980 by Terence Peter Nicholson describes a method of rotating a cooler core by alternately passing through a cooling fluid and the charging fluid through the same internal channels of the intercooler core. The purpose for the rotation is to alternate cooling and charging fluids.

### SUMMARY OF THE INVENTION

The present device includes an intercooler core which passes the charging medium or the charging air to be cooled prior to inlet into the internal combustion engine around the outer periphery of the core and passes a cooling medium normally a liquid fluid through axial channels and the hollow center of the core. The purpose for rotation is to increase the heat exchange of the outer surface of the core.

The present invention an intercooler assembly for cooling charge air to be delivered to an internal combustion engine comprising:
(a) a core assembly disposed along an axis in the an axial direction;
(b) the core assembly including an intercooler housing having a housing cavity for receiving an intercooler core therein;
(c) wherein cooling fluid is channeled axially through an axial chamber of the intercooler core for cooling the core and charge air is channeled around the outer surface of the core for cooling the charge air;
(d) wherein the core assembly further including a means for rotating the intercooler core about the axis thereby increasing the cooling of the charge air as it flows around the outer surface of the intercooler core.

Preferably wherein the rotating means including a motor connected to a drive sprocket driving a driven sprocket attached to the intercooler core thereby rotating the core.

Preferably wherein the rotating means including axial ribs projecting radially from the outer surface of the intercooler core for rotatably urging the intercooler core when air received through an air inlet in the intercooler housing impinges on the radial ribs.

Preferably wherein the intercooler housing including angled air passageways for directing the charge air at an angle towards the axial ribs.

Preferably wherein the rotating means including a turbine connected to the intercooler core, the core assembly adapted to direct cooling fluid over the turbine thereby rotating the core when cooling fluid passes over the turbine.

Preferably wherein the core assembly mounted to the intercooling housing with bearings and including seals to prevent cooling fluid from leaking form the axial chamber.

### BRIEF DESCRIPTION OF THE DRAWINGS

The present device will now be described by way of example only with reference to the following drawings in which:

FIG. 1 is a side schematic perspective view of an intercooler housing.

FIG. 2 is a side schematic perspective view of a core assembly.

FIG. 3 is a side schematic perspective view of an alternate embodiment of the core assembly.

FIG. 4 is side schematic perspective view of yet another alternate embodiment of the intercooler core assembly.

FIG. 5 is a partial cross sectional view of the core assembly shown in FIG. 4.

FIG. 6 is a partial cut away schematic perspective view of an entire intercooler assembly shown with the core assembly deployed within an intercooler housing.

FIG. 7 is an end elevational view of the intercooler assembly shown in FIG. 6.

FIG. 8 is a front schematic perspective view of an alternate embodiment of an intercooler assembly.

FIG. 9 is an end schematic elevational view of the intercooler assembly shown in FIG. 8.

FIG. 10 is a side schematic perspective view of an alternate embodiment of an intercooler assembly, with the intercooler core assembly shown in FIG. 4.

FIG. 11 is a side elevational view of the intercooler assembly shown in FIG. 10.

FIG. 12 is a side schematic perspective view of yet another alternate embodiment of the intercooler assembly.

FIG. 13 is a partial cross sectional view of the core assembly shown in FIG. 12.

### DETAILED DESCRIPTION OF THE PREFERRED EMBODIMENTS

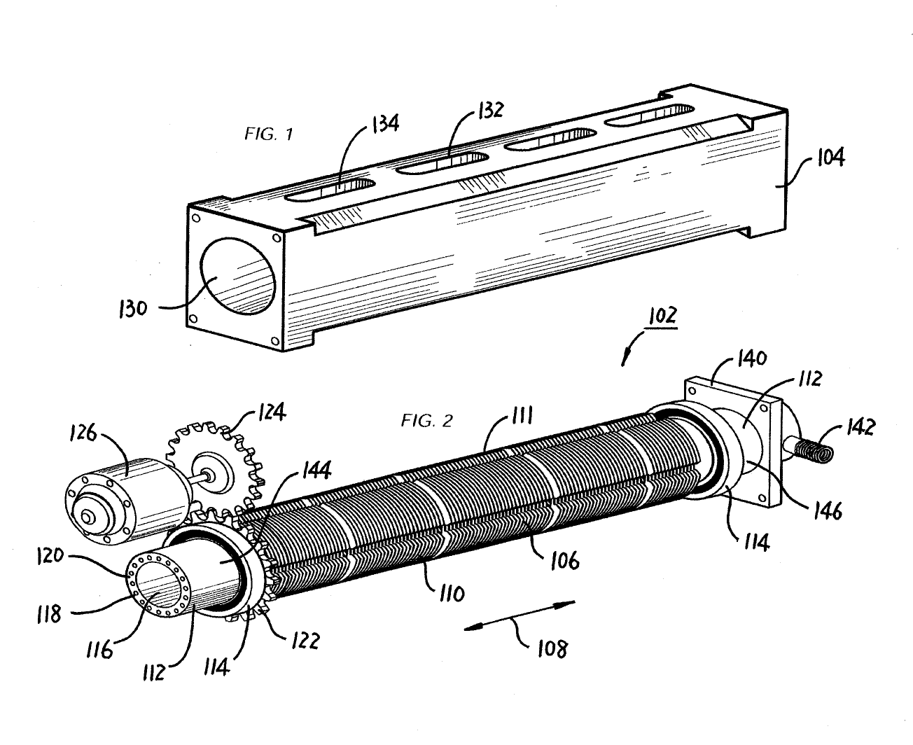

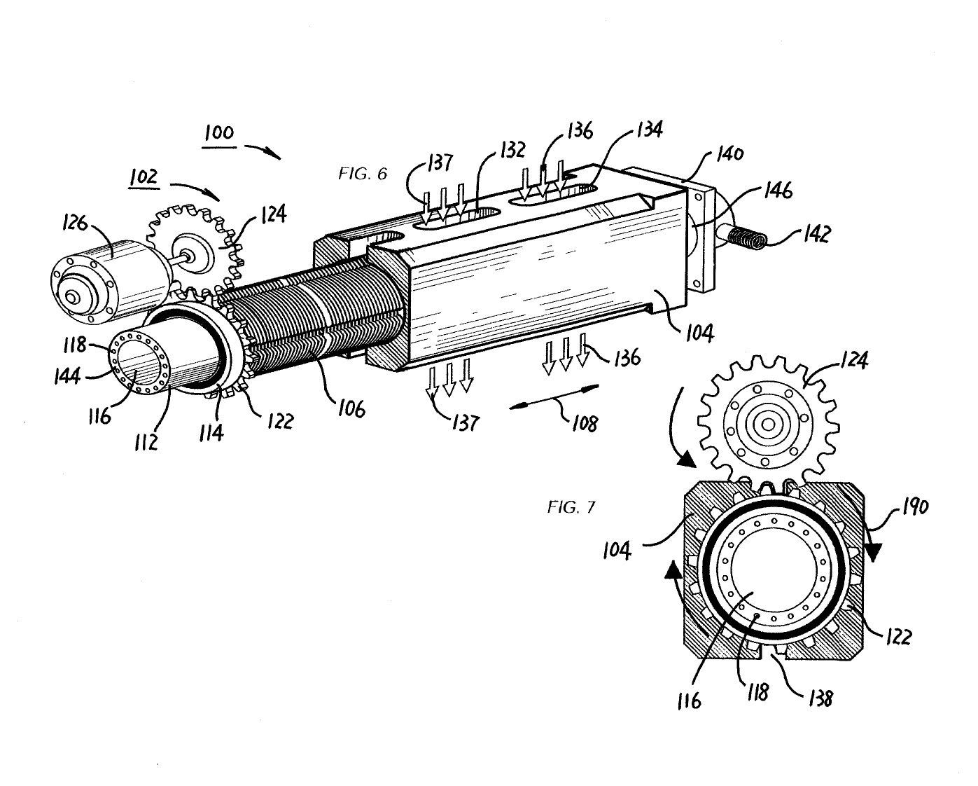

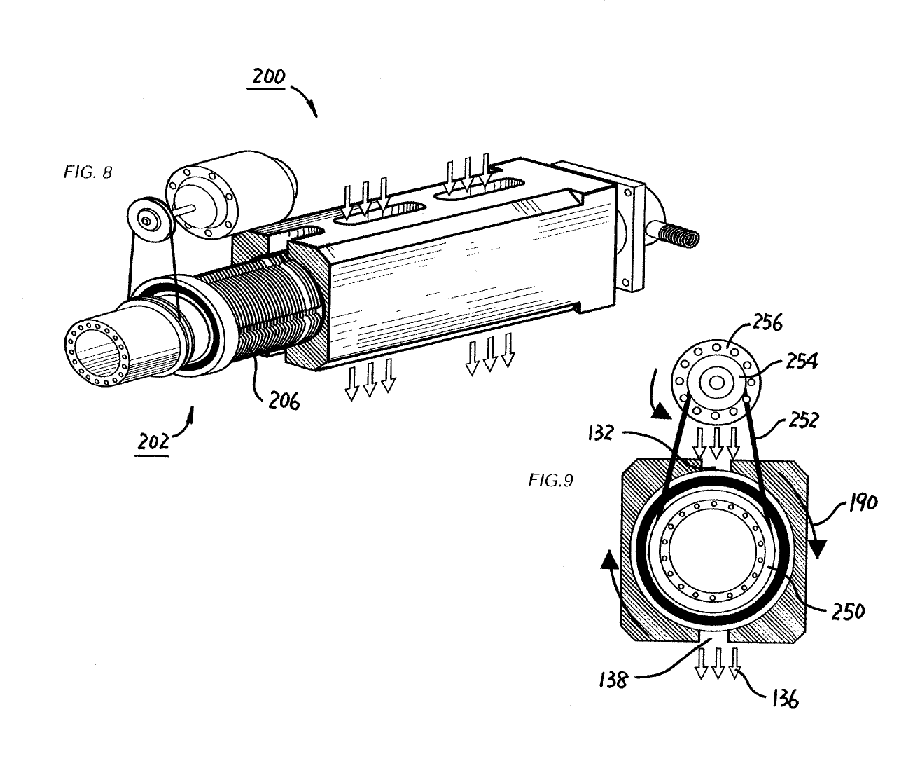

The present device an intercooler assembly depicted generally as 100 in FIG. 6 includes the following major components namely a core assembly 102 which is shown best in FIG. 2 and an intercooler housing 104 which is best shown in FIG. 1.

Core assembly 102 includes the following major components namely an intercooler core 106 oriented along an axial direction 108 including outer heat exchanging radial ribs 110 mounted about outer surface 111 and shoulder ends 112 which include supporting bearings 114.

Intercooler core 106 includes an axial chamber 117 which is made of a hollow center 116 which has there around axial channels 118 defined in the outer wall 120.

Intercooler 106 further includes a driven sprocket 122 which is driven by drive sprocket 124 which in turn is driven by motor 126.

Intercooler housing 104 includes a housing cavity 130 which will receive intercooler core 106 therein.

Intercooler housing 104 further includes air inlets 134 which direct air through air passage ways 134 thereby directing the air flow 136.

Intercooler housing 14 further includes an air outlet 138 thereby directing the outlet flow of airflow 136.

Intercooler assembly 100 further includes flanges 140 which include an outlet 142 at one end and not shown an inlet at the other end.

In the diagrams only one flange is shown however in practice there likely would be two flanges one mounted on the outlet end 146 similar to what is depicted and the other mounted on the inlet end 144.

Referring now to FIG. 5 intercooler core 106 normally would include a baffle 148 as shown in the cross sectional diagram and also would include seals 150 at both the inlet end 144 and the outlet end 146.

FIG. 5 also depicts the normal flow of air and fluids through the intercooler core. Namely cooling fluid 151 flows in the axial direction 108 through intercooler core 106 as shown by the arrows 150. The charging medium which normally is air is directed around the outer surface 111 of intercooler core 106.

The charging medium eventually leads its way into the internal combustion engine is depicted by the arrows denoted by air flow 136. Air flow 136 is in transverse direction to cooling fluid flow 150. Cooling fluid 151 is normally a liquid but other fluids such as gases may also be used.

Air flow 136 is typically around the outer periphery of intercooler core 106 and makes contact with ribs 110. The charging medium namely charge air 137 is cooled as it passes over outer surface 111. Charge air 137 is also referred to a simply air 137.

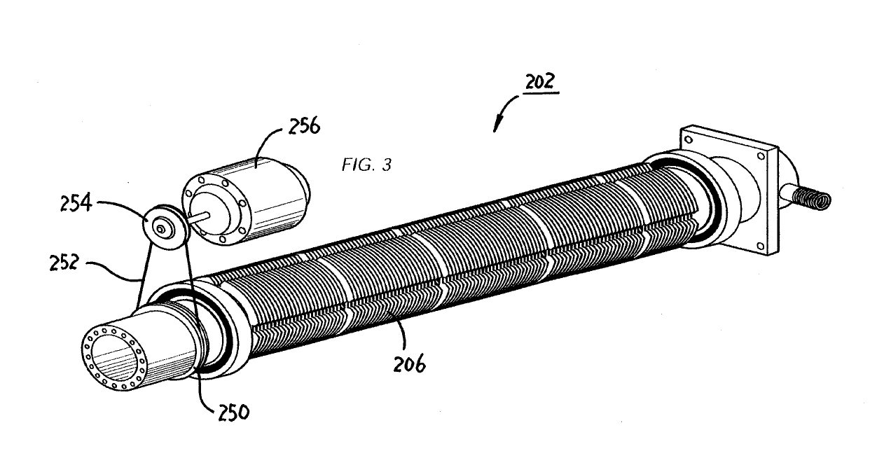

FIG. 3 shows an alternate embodiment namely core assembly 202 which includes an intercooler core 206 which includes a driven pulley 250, a drive belt 252 and a drive pulley 254 driven by motor 256. In all other aspects intercooler core 206 is similar to intercooler core 106.

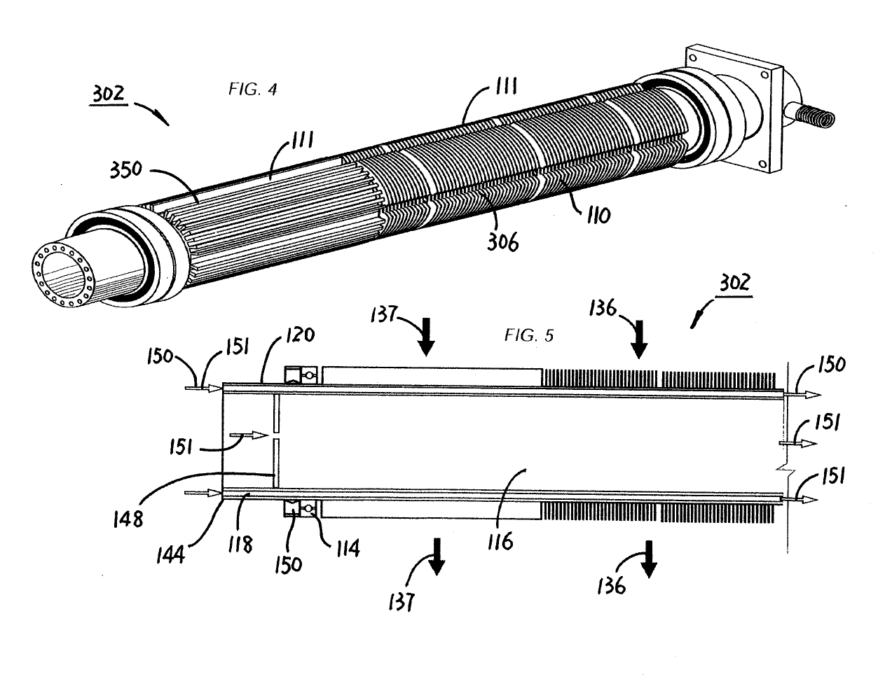

Referring now to FIGS. 4 & 5 yet another alternate embodiment of a core assembly namely core assembly 302 which includes an intercooler core 306 and also includes axial ribs 350 as well as radial ribs 110.

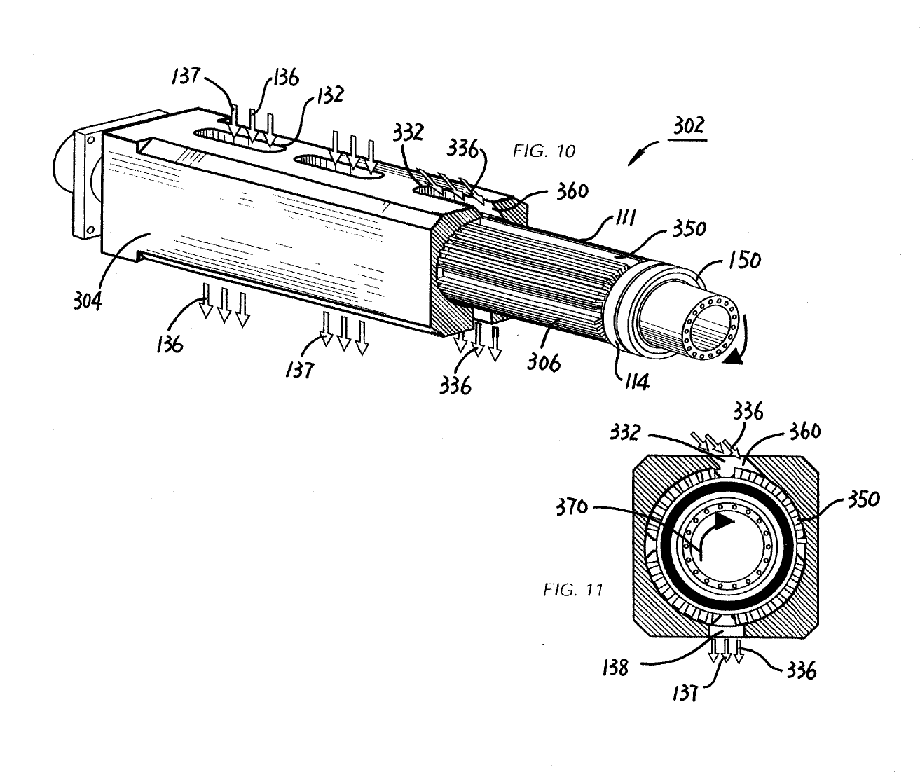

The purpose of axial ribs 350 is to create rotation of intercooler core 306 as depicted in FIGS. 10 & 11.

Referring now to FIGS. 10 & 11 which depict an intercooler assembly 302 which includes an intercooler housing 304 which includes air inlets 132 which are similar to the air inlets as depicted in FIGS. 1 creating airflow 136 and also includes air inlets 332 which are angled air passageways 360 which defines airflow 336.

The angled air passageways 360 are positioned above the axial ribs 350 in order to direct airflow 336 against the axial ribs 350 thereby initiating core rotation 370 in paddle wheel fashion.

Modified airflow 336 creates rotation of intercooler core 306 in the core rotation direction 370 as depicted in FIGS. 10 & 11.

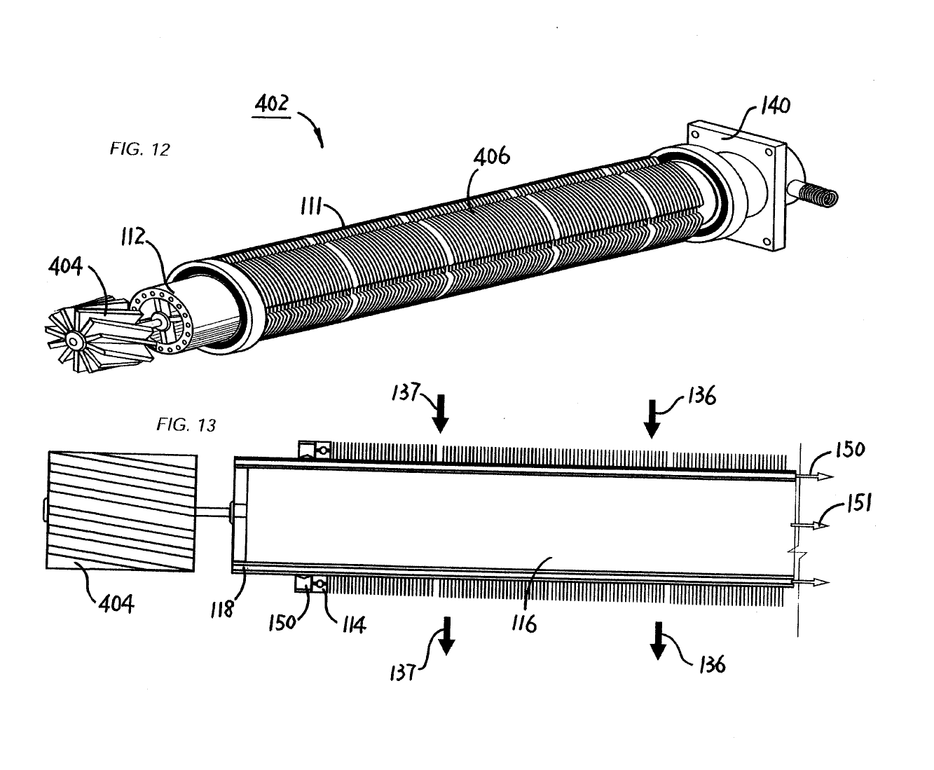

Referring now to FIGS. 12 and 13 which depicts another embodiment of the core assembly shown generally as 402 which includes a turbine 404, an intercooler core 406, an outer surface 111, an end shoulder 112 with cooling fluid 151 flowing through the intercooler core 406 shown as fluid flow 150 and air flow 137 flowing around outer surface 111 shown as air flow 136. As cooler fluid 151 flows over turbine 404 it creates rotation of turbine 404 which in turn rotates intercooler core 406. Cooling fluid 151 flows across turbine 404 and further on through axial extending channels 118 as well as through the hollow centre 116. The diagrams do not show the housing required in order to direct the flow of cooling fluid 151 through turbine 404 and then further on through the axial extending channels 118 and the hollow centre 116.

By using turbine 404 one can use the flow of cooling fluid 151 to rotate the intercooler core 406 rather than an external motor and gear and/or belt arrangement. The turbine 404 could be mounted to the entrance or exit of the intercooler core 406.

Intercooler core 406 in all other aspects is the same as intercooler core 106 other than the drive sprocket 124, motor 126 and driven sprocket 122 have been replaced by the turbine arrangement namely turbine 404.

The reader will note that the specification has shown four different examples of rotating core assembly 402 namely by using external driving means such as a motor 126 and drive sprockets 124 and driven sprockets 122 and/or a motor 256 with a drive belt 252 and/or by using axial ribs 350 and the airflow 136 and/or by using a turbine 404 and the fluid flow 150 there through.

### In Use

Referring to intercooler assembly 100 and intercooler assembly 200 having intercooler core 106 and intercooler core 206 respectively the intercooler core in these embodiments is driven by an external source namely either through a set of sprockets 122 and 124 and/or through a set of pulleys 250 and 254.

This mechanical drive arrangement rotates the intercooler core 106 and/or 206 in the rotation direction 190 as depicted in FIGS. 7 and FIG. 9.

Intercooler cores 106 and 206 both include radial ribs 110 only. There are no axial ribs 350 as in the third embodiment.

The inventor has found through significant experimentation that increased reduction in air 137 temperatures can be achieved by rotating intercooler core 106 and 206. In other words a greater air 137 temperature drop is achieved between air inlet 132 and the temperature at the air outlet 138 by rotating intercooler cores 106 and 206.

Referring now to the third embodiment namely intercooler assembly 302 which is depicted in FIGS. 4 and 5 as well as 10 and 11. The reader will note that intercooler core 306 not only includes radial ribs 110 as the conventional intercooler would have but also includes axial ribs 350.

The proportion of axial ribs 350 to the radial ribs 110 depends on a number of factors including the air velocity between air inlet 132 and air outlet 138 as well as the size of intercooler core and the size of the axial ribs 350 themselves.

Axial ribs 350 act as paddle wheels and air inlet 332 is oriented as an angled air passageway 360 as depicted in the diagrams in order to create radial airflow 336 which will turn intercooler core 306 in the core rotation direction 370 as depicted in FIG. 11.

Referring to FIG. 5 which is a schematic representation of the intercooler core 306 which includes radial rib 110 as well as axial ribs 350.

In most other aspects intercooler core 306 is similar to intercooler core 106 however eliminating the need for an external drive system including the drive sprockets and/or the drive pulleys as depicted in FIGS. 2 and 3.

FIG. 5 depicts flow of cooling fluid 151 as fluid flow 150 which normally is a liquid which is cooling intercooler core 306 as it is being heated by the air 137 flowing over ribs 110 and 350 on outer surface 111.

Intercooler core 306 normally includes a baffle 148 as does intercooler core 106 as well as intercooler core 206.

Most of the cooling fluid 151 is directed through the axially extending channels 118 which are oriented around the outer periphery of axial chamber 117 of the outer wall 120 of intercooler core 306.

The intercooler cores 106, 206 and 306 normally would include bearings 114 at each end to support the intercooler core as well as seals 150 to seal out the cooling fluid 151 from the outer surface 111 of the intercooler core.

Oriented in a transverse direction to fluid flow 150 is airflow 136 which flows around the outer surface 111 of intercooler core 306 due to its positioning within intercooler housing 104.

The intercooler housings 104 include air passageways 134 and air inlets 132 and/or air inlets 332 and angled air passageways 360 to create airflow 336.

The axial ribs 350 act as paddle wheels to incoming airflow 136 and in turn will rotate intercooler core 306 in the core rotation direction 370.

It should be apparent to persons skilled in the arts that various modifications and adaptation of this structure described above are possible without departure from the spirit of the invention the scope of which defined in the appended claim.

1. An intercooler assembly for cooling charge air to be delivered to an internal combustion engine comprising:
a) a core assembly disposed along an axis in the an axial direction;
b) the core assembly including an intercooler housing having a housing cavity for receiving an intercooler core therein;
c) wherein cooling fluid is channeled axially through an axial chamber of the intercooler core for cooling the core and charge air is channeled around the outer surface of the core for cooling the charge air;
d) wherein the core assembly further including a means for rotating the intercooler core about the axis thereby increasing the cooling of the charge air as it flows around the outer surface of the intercooler core.

2. The intercooler assembly claimed in claim 1 wherein the rotating means including a motor connected to a drive sprocket driving a driven sprocket attached to the intercooler core thereby rotating the core.

3. The intercooler assembly claimed in claim 1 wherein the rotating means including axial ribs projecting radially from the outer surface of the intercooler core for rotatably urging the intercooler core when air received through an air inlet in the intercooler housing impinges on the radial ribs.

4. The intercooler assembly claimed in claim 3 wherein the intercooler housing including angled air passageways for directing the charge air at an angle towards the axial ribs.

5. The intercooler assembly claimed in claim 1 wherein the rotating means including a turbine connected to the intercooler core, the core assembly adapted to direct cooling fluid over the turbine thereby rotating the core when cooling fluid passes over the turbine.

6. The intercooler assembly claimed in claim 1 wherein the core assembly mounted to the intercooling housing with bearings and including seals to prevent cooling fluid from leaking form the axial chamber.
